(19) United States
(12) Patent Application Publication
(10) Pub. No.: US 2024/0321112 A1
(43) Pub. Date: Sep. 26, 2024

(54) FLIGHT PATH REPORTING ENHANCEMENTS

(71) Applicant: QUALCOMM Incorporated, San Diego, CA (US)

(72) Inventors: Chiranjib SAHA, Lakeside, CA (US); Umesh PHUYAL, San Diego, CA (US); Drew Foster VAN DUREN, Templeton, CA (US)

(21) Appl. No.: 18/589,020

(22) Filed: Feb. 27, 2024

Related U.S. Application Data
(60) Provisional application No. 63/491,946, filed on Mar. 23, 2023.

(51) Int. Cl. G08G 5/00

(52) U.S. Cl. CPC G08G 5/0004; G08G 5/0017; G08G 5/003

(57) ABSTRACT

Methods, systems, and devices for wireless communications are described. Aerial user equipments (AUEs) may indicate flightpath information to the network (e.g., to a serving network entity). A network entity may request a flightpath report, which may include a sequence of expected geographic locations. An AUE may include estimated timestamps and uncertainty values associated with each timestamp with the flightpath report. Accordingly, the network may manage communications resources for the AUE accounting for the time and associated uncertainty that the AUE will be at each indicated point along the flightpath. A network entity may indicate a filter to apply to the flightpath report, and accordingly the AUE may report the portion of the flightpath that is relevant to the given network entity. The AUE may report the flightpath using an algebraic expression to reduce the amount of data as compared to a flightpath report that includes a set of waypoints.

### CROSS REFERENCE

The present application for patent claims the benefit of U.S. Provisional Patent Application No. 63/491,946 by SAHA et al., entitled “FLIGHT PATH REPORTING ENHANCEMENTS,” filed Mar. 23, 2023, assigned to the assignee hereof, and expressly incorporated by reference herein.

### FIELD OF TECHNOLOGY

The following relates to wireless communications, including flight path reporting enhancements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support flight path reporting enhancements. Aerial user equipments (AUEs) may indicate flightpath information to the network (e.g., to a serving network entity). The network may use flightpath information for resource management and planning purposes. During an initial access procedure with a network entity, a user equipment (UE) may indicate that the UE is an AUE, and in response, the network entity may transmit control signaling (e.g., radio resource control (RRC) signaling) requesting a flightpath report from the AUE. In response, the AUE may transmit a flightpath report. The flightpath report may include a sequence of expected geographic locations of the AUE. An AUE may include estimated timestamps and uncertainty values associated with each timestamp with the flightpath report. Accordingly, the network may manage communications resources for the AUE accounting for the time and associated uncertainty that the AUE will be at each indicated point along the flightpath. Additionally, or alternatively, a network entity may indicate a filter to apply to the flightpath report (e.g., a spatial filter, a temporal filter, or both). Accordingly, the AUE may report the portion of the flightpath that is relevant to the given network entity, thereby decreasing the amount of data in the flightpath report and/or allowing for more granularity in the flightpath reporting. Additionally, or alternatively, the AUE may report flightpaths using algebraic expressions for flightpaths that can be modeled using a mathematical or algebraic expression thereby reducing the amount of data used by flightpath reports as compared to a flightpath reports that include a set of waypoints.

A method for wireless communications at an AUE is described. The method may include receiving, from a network entity, control signaling including a request for the flightpath report from the AUE, and transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

An apparatus for wireless communications at an AUE is described. The apparatus may include a processor, memory coupled with the processor, and instructions stored in the memory. The instructions may be executable by the processor to cause the apparatus to receive, from a network entity, control signaling including a request for a flightpath report from the AUE, and transmit, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Another apparatus for wireless communications at an AUE is described. The apparatus may include means for receiving, from a network entity, control signaling including a request for a flightpath report from the AUE, and means for transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

A non-transitory computer-readable medium storing code for wireless communications at an AUE is described. The code may include instructions executable by a processor to receive, from a network entity, control signaling including a request for a flightpath report from the AUE, and transmit, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

In some examples of the method, apparatuses, and non-transitory computer-readable medium described herein, transmitting the flightpath report may include operations, features, means, or instructions for transmitting the flightpath report that indicates an algebraic equation representative of the sequence of expected geographic locations, where time may be an independent variable of the algebraic equation.

Some examples of the method, apparatuses, and non-transitory computer-readable medium described herein may further include operations, features, means, or instructions for receiving, with the control signaling, an indication of an option to include the set of time uncertainty values in the flightpath report.

In some examples of the method, apparatuses, and non-transitory computer-readable medium described herein, transmitting the flightpath report may include operations, features, means, or instructions for transmitting the flightpath report that indicates a set of geographic coordinates and altitudes for the AUE representative of the sequence of expected geographic locations.

In some examples of the method, apparatuses, and non-transitory computer-readable medium described herein, transmitting the flightpath report may include operations, features, means, or instructions for transmitting the flightpath report including a set of location uncertainty values corresponding to the sequence of expected geographic locations.

Some examples of the method, apparatuses, and non-transitory computer-readable medium described herein may further include operations, features, means, or instructions for transmitting, to the network entity, a second flightpath report including updated location uncertainty information corresponding to at least a portion of the sequence of expected geographic locations.

Some examples of the method, apparatuses, and non-transitory computer-readable medium described herein may further include operations, features, means, or instructions for receiving, with the control signaling, an indication of a coordinate system for reporting the sequence of expected geographic locations in the flightpath report.

Some examples of the method, apparatuses, and non-transitory computer-readable medium described herein may further include operations, features, means, or instructions for receiving, from the network entity, an indication of a set of multiple network entities along the sequence of expected geographic locations and monitoring for one or more messages from one or more of the set of multiple network entities based on the indication of the set of multiple network entities.

Some examples of the method, network entities, and non-transitory computer-readable medium described herein may further include operations, features, means, or instructions for transmitting, to the network entity during an initial access procedure with the network entity, an indication of a capability of the AUE to transmit the flightpath report.

A method for wireless communications at a network entity is described. The method may include transmitting, to an AUE, control signaling including a request for a flightpath report from the AUE, and receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

An apparatus for wireless communications at a network entity is described. The apparatus may include a processor, memory coupled with the processor, and instructions stored in the memory. The instructions may be executable by the processor to cause the apparatus to transmit, to an AUE, control signaling including a request for a flightpath report from the AUE, and receive, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Another apparatus for wireless communications at a network entity is described. The apparatus may include means for transmitting, to an AUE, control signaling including a request for ta flightpath report from the AUE, and means for receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

A non-transitory computer-readable medium storing code for wireless communications at a network entity is described. The code may include instructions executable by a processor to transmit, to an AUE, control signaling including a request for a flightpath report from the AUE, and receive, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

In some examples of the method, apparatuses, and non-transitory computer-readable medium described herein, receiving the flightpath report may include operations, features, means, or instructions for receiving the flightpath report that indicates an algebraic equation representative of the sequence of expected geographic locations, where time may be an independent variable of the algebraic equation.

Some examples of the method, apparatuses, and non-transitory computer-readable medium described herein may further include operations, features, means, or instructions for transmitting, with the control signaling, an indication of an option to include the set of time uncertainty values in the flightpath report.

In some examples of the method, apparatuses, and non-transitory computer-readable medium described herein, receiving the flightpath report may include operations, features, means, or instructions for receiving the flightpath report that indicates a set of geographic coordinates and altitudes for the AUE representative of the sequence of expected geographic locations.

In some examples of the method, apparatuses, and non-transitory computer-readable medium described herein, receiving the flightpath report may include operations, features, means, or instructions for receiving the flightpath report including a set of location uncertainty values corresponding to the sequence of expected geographic locations.

Some examples of the method, apparatuses, and non-transitory computer-readable medium described herein may further include operations, features, means, or instructions for receiving, from the AUE, a second flightpath report including updated location uncertainty information corresponding to at least a portion of the sequence of expected geographic locations.

Some examples of the method, apparatuses, and non-transitory computer-readable medium described herein may further include operations, features, means, or instructions for transmitting, with the control signaling, an indication of a coordinate system for reporting the sequence of expected geographic locations in the flightpath report.

Some examples of the method, apparatuses, and non-transitory computer-readable medium described herein may further include operations, features, means, or instructions for transmitting, to the AUE, an indication of a set of multiple network entities along the sequence of expected geographic locations.

Some examples of the method, network entities, and non-transitory computer-readable medium described herein may further include operations, features, means, or instructions for receiving, from the AUE during an initial access procedure with the AUE, an indication of a capability of the AUE to transmit the flightpath report.

A method for wireless communications at an AUE is described. The method may include receiving, from a network entity, control signaling including a request for a flightpath report from the AUE and indicating a filter to apply to the flightpath report, determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values, and transmitting, to the network entity and in response to the request, the flightpath report, where the flightpath report indicates the subset of expected geographic locations and the subset of expected time values.

An apparatus for wireless communications at an AUE is described. The apparatus may include a processor, memory coupled with the processor, and instructions stored in the memory. The instructions may be executable by the processor to cause the apparatus to receive, from a network entity, control signaling including a request for a flightpath report from the AUE and indicating a filter to apply to the flightpath report, determine, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values, and transmit, to the network entity and in response to the request, the flightpath report, where the flightpath report indicates the subset of expected geographic locations and the subset of expected time values.

Another aerial user equipment (AUE) for wireless communications is described. The aerial user equipment (AUE) for wireless communications may include means for receiving, from a network entity, control signaling including a request for a flightpath report from the AUE and indicating a filter to apply to the flightpath report, means for determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values, and means for transmitting, to the network entity and in response to the request, the flightpath report, where the flightpath report indicates the subset of expected geographic locations and the subset of expected time values.

A non-transitory computer-readable medium storing code for wireless communications at an AUE is described. The code may include instructions executable by a processor to receive, from a network entity, control signaling including a request for a flightpath report from the AUE and indicating a filter to apply to the flightpath report, determine, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values, and transmit, to the network entity and in response to the request, the flightpath report, where the flightpath report indicates the subset of expected geographic locations and the subset of expected time values.

In some examples of the method, apparatuses, and non-transitory computer-readable medium described herein, receiving the control signaling including an indication of the filter may include operations, features, means, or instructions for receiving an indication of a geographic area corresponding to the filter, where the subset of expected geographic locations may be located within the geographic area.

In some examples of the method, apparatuses, and non-transitory computer-readable medium described herein, the indication of the geographic area includes an indication of a center coordinate and a radius, a list of zone identifiers corresponding to geographic zones, or a combination thereof.

In some examples of the method, apparatuses, and non-transitory computer-readable medium described herein, receiving the control signaling including an indication of the filter may include operations, features, means, or instructions for receiving an indication of a time period corresponding to the filter, where the subset of expected geographic locations correspond to the subset of expected time values within the time period.

Some examples of the method, apparatuses, and non-transitory computer-readable medium described herein may further include operations, features, means, or instructions for receiving, with the control signaling, an indication of a set of spatial filters, where the filter may be a spatial filter, where the set of spatial filters includes the spatial filter, where each spatial filter includes a geographic area and an applicable altitude range, and where the spatial filter to apply may be selected by the AUE based on an altitude of the AUE being within the applicable altitude range of the spatial filter.

Some examples of the method, apparatuses, and non-transitory computer-readable medium described herein may further include operations, features, means, or instructions for receiving, with the control signaling, an indication of a set of filters and a set of corresponding times at which each of the set of filters may be applicable, where the set of filters includes the filter, and where the filter to apply may be selected by the AUE based on a time at which the AUE transmits the flightpath report.

In some examples of the method, apparatuses, and non-transitory computer-readable medium described herein, receiving the control signaling may include operations, features, means, or instructions for receiving a broadcast message indicating the filter and receiving a control message including the request for the flightpath report.

In some examples of the method, apparatuses, and non-transitory computer-readable medium described herein, receiving the control signaling may include operations, features, means, or instructions for receiving a single control message including the request for the flightpath report and indicating the filter.

In some examples of the method, apparatuses, and non-transitory computer-readable medium described herein, transmitting the flightpath report may include operations, features, means, or instructions for transmitting the flightpath report that indicates an algebraic equation representative of the subset of expected geographic locations, where time may be an independent variable of the algebraic equation.

Some examples of the method, apparatuses, and non-transitory computer-readable medium described herein may further include operations, features, means, or instructions for transmitting the flightpath report that indicates a set of geographic coordinates and altitudes for the AUE representative of the subset of expected geographic locations.

Some examples of the method, apparatuses, and non-transitory computer-readable medium described herein may further include operations, features, means, or instructions for transmitting, to the network entity during an initial access procedure with the network entity, an indication of a capability of the AUE to transmit the flightpath report, where the control signaling including the request for the flightpath report may be responsive to the indication of the capability.

A method for wireless communications at a network entity is described. The method may include transmitting, to an AUE, control signaling including a request for a flightpath report from the AUE and indicating a filter to apply to the flightpath report and receiving, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

An apparatus for wireless communications at a network entity is described. The apparatus may include a processor, memory coupled with the processor, and instructions stored in the memory. The instructions may be executable by the processor to cause the apparatus to transmit, to an AUE, control signaling including a request for a flightpath report from the AUE and indicating a filter to apply to the flightpath report and receive, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

Another apparatus for wireless communications at a network entity is described. The apparatus may include means for transmitting, to an AUE, control signaling including a request for a flightpath report from the AUE and indicating a filter to apply to the flightpath report and means for receiving, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

A non-transitory computer-readable medium storing code for wireless communications at a network entity is described. The code may include instructions executable by a processor to transmit, to an AUE, control signaling including a request for a flightpath report from the AUE and indicating a filter to apply to the flightpath report and receive, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

In some examples of the method, apparatuses, and non-transitory computer-readable medium described herein, transmitting the control signaling including an indication of the filter may include operations, features, means, or instructions for transmitting an indication of a geographic area corresponding to the filter, where the sequence of expected geographic locations may be located within the geographic area.

In some examples of the method, apparatuses, and non-transitory computer-readable medium described herein, the indication of the geographic area includes an indication of a center coordinate and a radius, a list of zone identifiers corresponding to geographic zones, or a combination thereof.

In some examples of the method, apparatuses, and non-transitory computer-readable medium described herein, transmitting the control signaling including an indication of the filter may include operations, features, means, or instructions for transmitting an indication of a time period corresponding to the filter, where the sequence of expected geographic locations correspond to the set of expected time values within the time period.

Some examples of the method, apparatuses, and non-transitory computer-readable medium described herein may further include operations, features, means, or instructions for transmitting, with the control signaling, an indication of a set of spatial filters, where the filter may be a spatial filter, where the set of spatial filters includes the spatial filter, where each spatial filter includes a geographic area and an applicable altitude range, and where the spatial filter applied by the AUE may be based on an altitude of the AUE being within the applicable altitude range of the spatial filter.

Some examples of the method, apparatuses, and non-transitory computer-readable medium described herein may further include operations, features, means, or instructions for transmitting, with the control signaling, an indication of a set of filters and a set of corresponding times at which each of the set of filters may be applicable, where the set of filters includes the filter, and where the filter applied by the AUE may be based on a time at which the AUE transmits the flightpath report.

In some examples of the method, apparatuses, and non-transitory computer-readable medium described herein, transmitting the control signaling may include operations, features, means, or instructions for transmitting a broadcast message indicating the filter and transmitting a control message including the request for the flightpath report.

In some examples of the method, apparatuses, and non-transitory computer-readable medium described herein, transmitting the control signaling may include operations, features, means, or instructions for transmitting a single control message including the request for the flightpath report and indicating the filter.

In some examples of the method, apparatuses, and non-transitory computer-readable medium described herein, receiving the flightpath report may include operations, features, means, or instructions for receiving the flightpath report that indicates an algebraic equation representative of the sequence of expected geographic locations, where time may be an independent variable of the algebraic equation.

In some examples of the method, apparatuses, and non-transitory computer-readable medium described herein, receiving the flightpath report may include operations, features, means, or instructions for receiving the flightpath report that indicates a set of geographic coordinates and altitudes for the AUE representative of the sequence of expected geographic locations.

Some examples of the method, apparatuses, and non-transitory computer-readable medium described herein may further include operations, features, means, or instructions for receiving, from the AUE during an initial access procedure with the AUE, an indication of a capability of the AUE to transmit the flightpath report, where the control signaling including the request for the flightpath report may be responsive to the indication of the capability.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports flight path reporting enhancements in accordance with one or more aspects of the present disclosure.

FIG. 2 shows an example of a wireless communications system that supports flight path reporting enhancements in accordance with one or more aspects of the present disclosure.

FIG. 3 shows an example of a process flow that supports flight path reporting enhancements in accordance with one or more aspects of the present disclosure.

FIG. 4 shows an example of a process flow that supports flight path reporting enhancements in accordance with one or more aspects of the present disclosure.

FIGS. 5 and 6 show block diagrams of devices that support flight path reporting enhancements in accordance with one or more aspects of the present disclosure.

FIG. 7 shows a block diagram of a communications manager that supports flight path reporting enhancements in accordance with one or more aspects of the present disclosure.

FIG. 8 shows a diagram of a system including a device that supports flight path reporting enhancements in accordance with one or more aspects of the present disclosure.

FIGS. 9 and 10 show block diagrams of devices that support flight path reporting enhancements in accordance with one or more aspects of the present disclosure.

FIG. 11 shows a block diagram of a communications manager that supports flight path reporting enhancements in accordance with one or more aspects of the present disclosure.

FIG. 12 shows a diagram of a system including a device that supports flight path reporting enhancements in accordance with one or more aspects of the present disclosure.

FIGS. 13 through 16 show flowcharts illustrating methods that support flight path reporting enhancements in accordance with one or more aspects of the present disclosure.

### DETAILED DESCRIPTION

In some wireless communications systems, a user equipment (UE) may be an unmanned aerial vehicle (UAV) or a drone. Such aerial UEs (AUEs) may indicate flightpath information to the network (e.g., to a serving network entity). The network may use flightpath information for resource management and planning purposes. For example, based on flightpath information, the network may plan which beams to use for communications with the AUEs. As another example, based on flightpath information from multiple AUEs, the network may determine how may AUEs a given cell will serve at a given time. As another example, based on the flightpath information, the network may estimate times for handovers between cells. During an initial access procedure with a network entity, a UE may indicate that the UE is an AUE, and in response, the network entity may transmit control signaling (e.g., radio resource control (RRC) signaling) requesting a flightpath report from the AUE. In response, the AUE may transmit a flightpath report that indicates a sequence of waypoints. A sequence of waypoints, however, may not be useful for resource management and planning purposes absent an estimated time associated with each waypoint and an uncertainty/confidence estimate for each estimated time. For example, environmental conditions such as wind conditions may cause uncertainty in time. Additionally, or alternatively, an entire flightpath may not be relevant for a given network entity. For example, the portion of a flightpath that is within the geographic region served by a given network entity may be relevant to that network entity. Additionally, or alternatively, reporting a set of waypoints may be data-intensive for certain flightpaths.

An AUE may include estimated timestamps and uncertainty values associated with each timestamp with the flightpath report. Accordingly, the network may manage communications resources for the AUE accounting for the time and associated uncertainty that the AUE will be at each indicated point along the flightpath. Additionally, or alternatively, a network entity may indicate, for example either in system information (SI) or in the flightpath request message, a filter to apply to the flightpath report (e.g., a spatial filter, a temporal filter, or both). Accordingly, the AUE may report the portion of the flightpath that is relevant to the given network entity, thereby decreasing the amount of data in the flightpath report and/or allowing for more granularity in the flightpath reporting. Additionally, or alternatively, the AUE may report a flightpath using an expression for a flightpath that can be modeled using a mathematical or algebraic expression (e.g., for circular, elliptical, or patterned flightpaths). The algebraic or mathematical expression may include time as an independent variable, thereby reducing the amount of data used by the flightpath report as compared to a flightpath report that includes a set of waypoints.

Aspects of the disclosure are initially described in the context of wireless communications systems. Aspects of the disclosure are further illustrated by and described with reference to process flows, apparatus diagrams, system diagrams, and flowcharts that relate to flight path reporting enhancements.

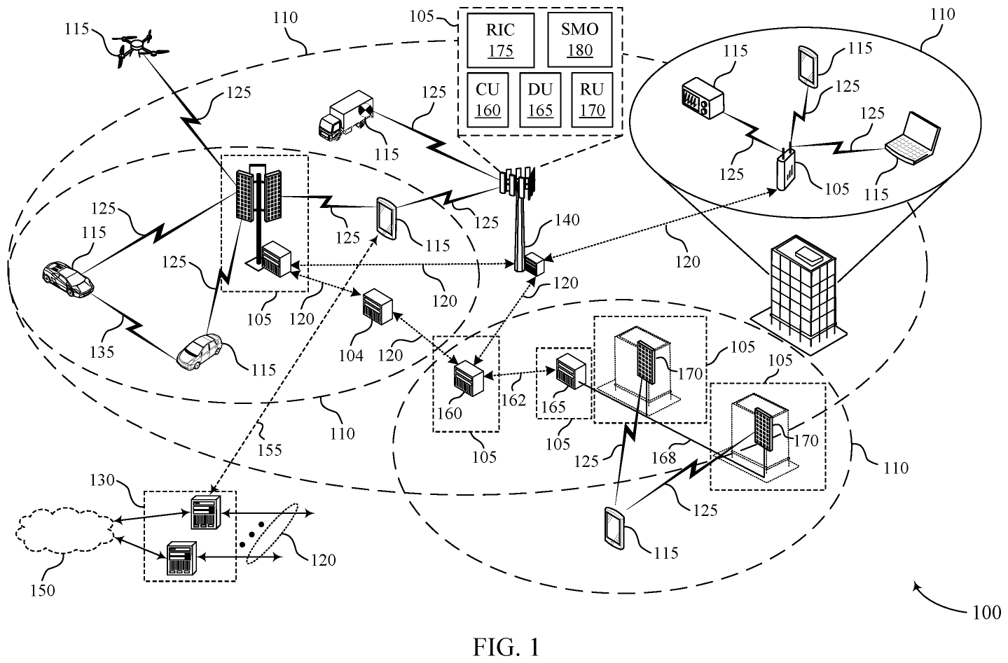

FIG. 1 shows an example of a wireless communications system 100 that supports flight path reporting enhancements in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support flight path reporting enhancements as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some UEs 115 in the wireless communications systems may be AUEs 115 (e.g., may be UAVs or drones). AUEs 115 may indicate flightpath information to the network (e.g., to a serving network entity 105). The network may use flightpath information for resource management and planning purposes. During an initial access procedure with a network entity 105, a UE 115 may indicate that the UE 115 is an AUE 115, and in response, the network entity 105 may transmit control signaling (e.g., RRC signaling) requesting a flightpath report from the AUE 115. In response, the AUE 115 may transmit a flightpath report. The flightpath report may include a sequence of expected geographic locations of the AUE 115. An AUE 115 may include estimated timestamps and uncertainty values associated with each timestamp with the flightpath report. Accordingly, the network may manage communications resources for the AUE 115 accounting for the time and associated uncertainty that the AUE 115 will be at each indicated point along the flightpath. Additionally, or alternatively, a network entity 105 may indicate a filter to apply to the flightpath report (e.g., a spatial or temporal filter). Accordingly, the AUE 115 may report the portion of the flightpath that is relevant to the given network entity 105, thereby decreasing the amount of data in the flightpath report and/or allowing for more granularity in the flightpath reporting. Additionally, or alternatively, the AUE 115 may report flightpaths using algebraic expressions for flightpaths that can be modeled using a mathematical or algebraic expression thereby reducing the amount of data used by flightpath reports as compared to a flightpath reports that include a set of waypoints.

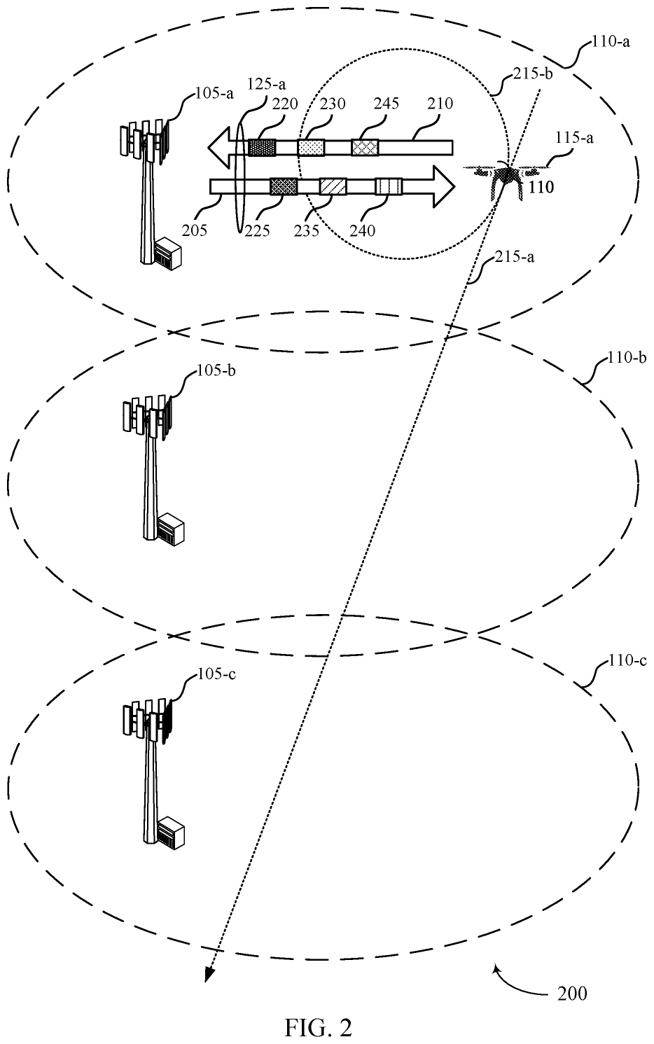

FIG. 2 shows an example of a wireless communications system 200 that supports flight path reporting enhancements in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. For example, the UE 115-a may be an AUE as described herein. The wireless communications system 200 may include a network entity 105-a, a network entity 105-b, and a network entity 105-c, which may be examples of network entities 105 as described herein. The network entity 105-a may support a coverage area 110-a, the network entity 105-b may support a coverage area 110-b, and the network entity 105-c may support a coverage area 110-c.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the UE 115-a may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-a using the communication link 125-a.

The UE 115-a may be programmed with flightpath information. A flightpath may be a sequence of waypoints and optionally timestamps. For example, the UE 115-a may have a flightpath 215-a which takes the UE 115-a through the coverage area 110-a, the coverage area 110-b, and the coverage area 110-c. As another example, the UE 115-a may be configured to have a circular flightpath 215-b (e.g., the UE 115-a may be programmed to circle around a point).

The flightpath information may be indicated to the network through RRC signaling. For example, the UE 115-a may indicate in a random access channel (RACH) message 220 (e.g., during an initial access procedure with the network entity 105-a) that the UE 115-a is a AUE or that the UE 115-a is capable of reporting flightpath information. The network entity 105-a may transmit a flightpath request 225 (e.g., via RRC). In response to the flightpath request 225, the UE 115-a may transmit a flightpath report 230 (e.g., via RRC). In some examples, the flightpath report 230 may include a sequence of waypoints (e.g., a sequence of expected geographic locations) and corresponding timestamps. The network entity 105-a may indicate a maximum number of waypoints to report in the flightpath request 225.

In some cases, an AUE (e.g., the UE 115-a) may have a guidance system that is configured to follow a position trajectory but allow for time variability at each position (e.g., if the AUE is tracking train tracks for inspection). In such cases, the spatial (e.g., geographic location) confidence may be close to 100%, but temporal certainty may be variable and a function of how “on schedule” the AUE is, which may be subject to atmospheric conditions such as winds. As described herein, temporal variation and uncertainty may be computed by the UE 115-a and transmitted in the flightpath report 230. In some cases, an AUE (e.g., the UE 115-a) may be configured to attempt to maintain both spatial and time uncertainty within permissible, reportable bounds. In some cases, the guidance system of an AUE (e.g., the UE 115-a) may be configured to have lower confidence in future spatial positions at the expense of high time certainty (e.g., an ellipsoid).

The expected geographic locations may be reported in the flightpath report 230 in several ways. For example, the expected geographic locations may be reported as an ellipsoid point, an ellipsoid point with an uncertainty circle, an ellipsoid point with an uncertainty ellipsoid, a polygon, an ellipsoid point with altitude, an ellipsoid point with altitude and an uncertainty ellipsoid, an ellipsoid arc, a high accuracy ellipsoid point with an uncertainty ellipsoid, a high accuracy ellipsoid point with a scalable uncertainty ellipsoid e, a high accuracy ellipsoid point with altitude and an uncertainty ellipsoid, or a high accuracy ellipsoid point with altitude and a scalable uncertainty ellipsoid. To account for the time uncertainty, timestamps and time uncertainty values corresponding to the expected geographic locations may be reported in the flightpath report 230. For example, a timestamp may be an expected time-instance, and the time uncertainty may be the standard deviation of the time-instance when the UE 115-a will be located at the indicated geographic location.

In some examples, the definition of “waypoint” in RRC signaling may include time as a fourth dimension (e.g., including a timestamp and a time-uncertainty value). In some examples, the flightpath request 225 may indicate that timestamps and time uncertainty values are optional (e.g., may be indicated as optional flags). In such examples where the flightpath indicates that the that timestamps and time uncertainty values are optional, the flightpath report 230 may include information elements AbsoluteTimeInfo and timestampUncertainty. The information element AbsoluteTimeInfo may indicate an absolute time in a format YY-MM-DD HH:MM:SS and using binary-coded decimal (BCD) encoding.

In some cases, the flightpath 215-a may take the UE 115-a through the coverage area 110-a, the coverage area 110-b, and the coverage area 110-c. In response to the flightpath 215-a taking the UE 115-a through the different coverage areas, the network entity 105-a may transmit a message 240 indicating the network entities 105 to which the UE 115-a may connect and corresponding times the UE 115-a may enter the coverage areas 110 of those network entities. For example, the network entity 105-a may indicate in the message 240 the time the UE 115-a will enter the coverage area 110-b and the time the UE 115-a will enter the coverage area 110-c, which may aid the UE 115-a in accessing (e.g., performing RACH procedures with) the network entity 105-b and the network entity 105-c.

In some cases, the UE 115-a may have a flightpath configured by an application layer or an upper layer, and there may be uncertainty as to which sequency of waypoints the UE 115-a should report in the flightpath report 230. For example, if the UE 115-a has a detailed flightpath (e.g., 1000 waypoints), but the flightpath request 225 requests for the UE 115-a to report 100 waypoints, there be uncertainty for the UE 115-a as to how to select the 100 waypoints. As another example, if the UE 115-a has a long flightpath (e.g., over 100 kilometers), the entire flightpath may not be relevant to a given network entity. For example, the flightpath 215-a may take the UE 115-a through the coverage area 110-a, the coverage area 110-b, and the coverage area 110-c, but only the waypoints in the coverage area 110-a may be relevant to the network entity 105-a. For example, the network entity 105-a may use the flightpath information for resource management (e.g., based on a quantity of UEs 115 within the coverage area 110-a and at different locations within the coverage area 110-a at a given time), for beam management for the UE 115-a, and/or for scheduling handovers, and accordingly the portions of the flightpath 215-a that are outside of the coverage area 110-a may not be relevant to the network entity 105-a.

Accordingly, in some examples, the network entity 105-a may indicate a flightpath filter reporting configuration to the UE 115-a. A flightpath filter may be interpreted as a union of intervals (e.g., open or closed intervals) in space-time. The UE 115-a may sample waypoints to be reported in the flightpath report 230 from the intersection of the actual flightpath (e.g., the flightpath 215-a) and the configured filter. In some examples, the network entity 105-a may broadcast or transmit signaling that indicates the filter (e.g., in an SI message 235). In some examples, the network entity 105-a may indicate the filter in the RRC signaling that includes the flightpath request 225. In some examples, the network entity 105-a may broadcast an indication of multiple candidate filters, and the flightpath request 225 may indicate a selected filter from the multiple candidate filters. In some examples, the filter may be a disc of a given radius and center (e.g., in latitude and longitude coordinates). In some examples, the filter may be indicated by a list of 3-dimensional zones (e.g., where the zones may be indicated by an SI message 235) and/or a list of zone identifiers (IDs). In some examples, the filter may be given as a list of 2-dimensional spatial filters valid for different altitudes (e.g., disc of radius 1 valid up to H meters, disc of radius 2 valid beyond H meters), as cell coverage may at different heights may vary. In some examples, the SI message 235 or the flightpath request 225 may indicate a list of different filters that are valid at different times, and the UE 115-a may apply a filter based on the time at which the UE 115-a transmits the flightpath report 230. The network entity 105-b and the network entity 105-c may similarly provide filters for the UE 115-a to apply to flightpath reports the UE 115-a transmits to the network entity 105-b and the network entity 105-c when the UE 115-a establishes a connection with the network entity 105-b and the network entity 105-c.

In some examples, a flightpath may be more efficiently reported in ways other than a sequence of waypoints. For example, four-dimensional trajectory descriptions may be data-intensive if reported in high resolution or at high rates. For example, American Society for Testing and Materials (ASTM) Level 1 extension markers may be used to accommodate more efficient mathematical representations of flightpath information. For example, some flightpaths may be spatially repetitive, such as: 1) orbits around a position X from time t0 to t1; 2) hovering at position Y for a time period; or 3) maintaining a standard tear-drop holding pattern for n orbits or a time period. As another example, a polynomial expression over earth-centered earth-fixed (ECEF) coordinates that may be converted into an unlimited number of latitude/longitude/altitude positions at a particular ellipsoid may be used to represent the flightpath (e.g., World Geodetic System 1984). Accordingly, the flightpath information may be indicated in the flightpath report 230 as a mathematical or algebraic expression (e.g., with time as an independent variable. For example, as shown in FIG. 2, the flightpath 215-b is circular, and the position at time t (e.g., (x(t), y(t))) assuming the center of the circle is at point (0,0) may accordingly be given by (r*cos(0(t)), r*sin(θ(t))), where r is the radius of the circle, θ(t) is the angle between the UE 115-a and the a-axis at time t. Accordingly, as described herein, the coordinate system may be predefined (e.g., previously known to the UE 115-a and the network entity 105-a), signaled by the network (e.g., in the flightpath request 225 or in an SI message 235), or signaled by the UE 115-a (e.g., in the flightpath report 230).

In some examples, delta trajectories or flightpath information may be reported, for example, in an updated flightpath report 245. For example, a reported trajectory may be no different than a previously reported trajectory (e.g., in a flightpath report 230), but the confidence levels in the later 4-dimensional points may be higher (e.g., the wind may be predictable and unchanging). In such cases, the updated flightpath report 245 may report updated confidence/uncertainty values (for time and/or location) at given points/times along the flightpath without retransmitting the entire sequence of geographic locations (e.g., without transmitting a flightpath report with an entire trajectory).

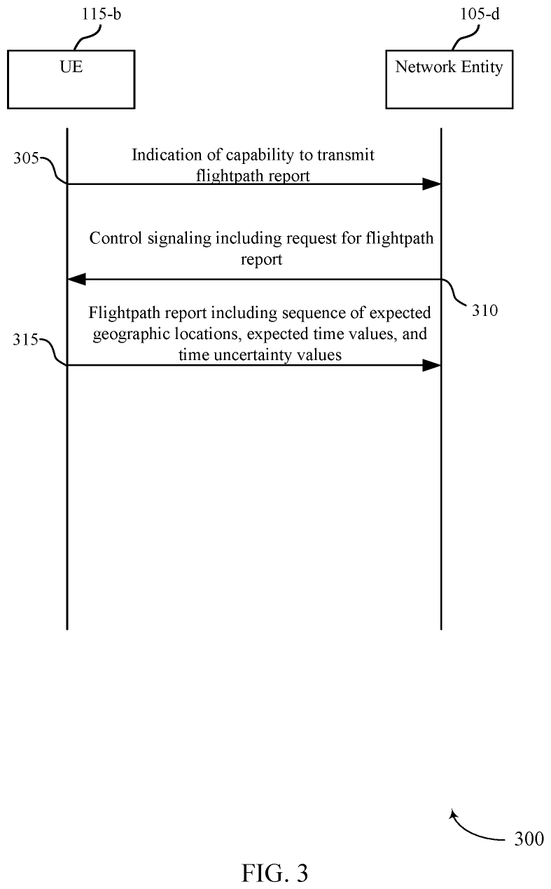

FIG. 3 shows an example of a process flow 300 that supports flight path reporting enhancements in accordance with one or more aspects of the present disclosure. The process flow 300 may include a UE 115-b, which may be an example of a UE 115 as described herein. For example, the UE 115-b may be an AUE as described herein. The process flow 300 may include a network entity 105-d, which may be an example of a network entity 105 as described herein. In the following description of the process flow 300, the operations between the network entity 105-d and the UE 115-b may be transmitted in a different order than the example order shown, or the operations performed by the network entity 105-d and the UE 115-b may be performed in different orders or at different times. Some operations may also be omitted from the process flow 300, and other operations may be added to the process flow 300.

At 305, the UE 115-b may transmit, to the network entity 105-d during an initial access procedure with the network entity 105-d, an indication of a capability of the UE 115-b to transmit a flightpath report.

At 310, the UE 115-b may receive, from the network entity 105-d and in response to the indication of the capability, control signaling including a request for the flightpath report from the UE 115-b.

At 315, the UE 115-b may transmit, to the network entity 105-d and in response to the request, the flightpath report. The flightpath report indicates a sequence of expected geographic locations along an expected flightpath for the UE 115-b, a set of expected time values corresponding to the sequence of expected geographic locations, and a set of time uncertainty values corresponding to the set of expected time values.

In some examples, the flightpath report indicates an algebraic equation representative of the sequence of expected geographic locations, where time is an independent variable of the algebraic equation. In some examples, the flightpath report indicates a set of geographic coordinates and altitudes for the UE 115-b representative of the sequence of expected geographic locations.

In some examples, the UE 115-b may receive, with the control signaling, an indication of an option to include the set of time uncertainty values in the flightpath report.

In some examples, the flightpath report includes a set of location uncertainty values corresponding to the sequence of expected geographic locations. In some examples, the UE 115-b transmits, to the network entity 105-d, a second flightpath report including updated location uncertainty information corresponding to at least a portion of the sequence of expected geographic locations.

In some examples, the UE 115-b may receive, with the control signaling, an indication of a coordinate system for reporting the sequence of expected geographic locations in the flightpath report.

In some examples, the UE 115-b may receive, from the network entity 105-d, an indication of one or more network entities 105 along the sequence of expected geographic locations. In such examples, the UE 115-b may monitor for one or more messages from one or more of the network entities based on the indication of the one or more network entities.

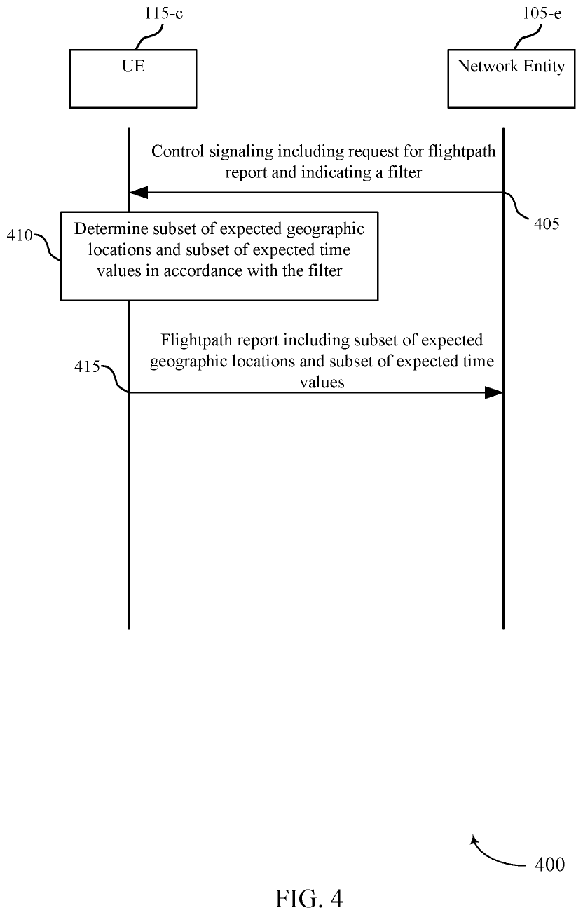

FIG. 4 shows an example of a process flow 400 that supports flight path reporting enhancements in accordance with one or more aspects of the present disclosure. The process flow 400 may include a UE 115-c, which may be an example of a UE 115 as described herein. For example, the UE 115-c may be an AUE as described herein. The process flow 400 may include a network entity 105-e, which may be an example of a network entity 105 as described herein. In the following description of the process flow 400, the operations between the network entity 105-e and the UE 115-c may be transmitted in a different order than the example order shown, or the operations performed by the network entity 105-e and the UE 115-c may be performed in different orders or at different times. Some operations may also be omitted from the process flow 400, and other operations may be added to the process flow 400.

At 405, the UE 115-c may receive, from the network entity 105-e, control signaling including a request for a flightpath report from the UE 115-c and indicating a filter to apply to the flightpath report.

At 410, the UE 115-c may determine, in accordance with the filter and from flightpath information for the UE 115-c including a sequence of expected geographic locations along an expected flightpath for the UE 115-c and a set of expected time values corresponding to the sequence of expected geographic locations, a subset of expected geographic locations of the sequence of expected geographic locations and a subset of expected time values of the set of expected time values.

At 415, the UE 115-c may transmit, to the network entity 105-e and in response to the request, the flightpath report, where the flightpath report indicates the subset of expected geographic locations and the subset of expected time values. From the perspective of the network entity 105-e, the network entity 105-e receives a flightpath report that indicates a sequence of expected geographic locations along an expected flightpath for the UE 115-c and a set of expected time values corresponding to the sequence of expected geographic locations, and each of the sequence of expected geographic locations is congruent with the filter.

In some examples, the indication of the filter indicates a geographic area corresponding to the filter (e.g., the filter is a spatial filter), and the subset of expected geographic locations are located within the geographic area. In some examples, the indication of the geographic area includes an indication of a center coordinate and a radius, a list of zone identifiers corresponding to geographic zones, or a combination thereof.

In some examples, the indication of the filter indicates a time period corresponding to the filter and the subset of expected geographic locations correspond to the subset of expected time values within the time period.

In some examples, the UE 115-c may receive, with the control signaling, an indication of a set of spatial filters, where the filter is a spatial filter, where the set of spatial filters includes the spatial filter, where each spatial filter includes a geographic area and an applicable altitude range, and the spatial filter to apply is selected by the UE 115-c based on an altitude of the UE 115-c being within the applicable altitude range of the spatial filter.

In some examples, the UE 115-c may receive, with the control signaling, an indication of a set of filters and a set of corresponding times at which each of the set of filters is applicable, where the set of filters includes the filter, and where the filter to apply is selected by the UE 115-c based on a time at which the UE 115-c transmits the flightpath report.

In some examples, the UE 115-c may receive a broadcast message (e.g., an SI message) indicating the filter and a separate control message (e.g., RRC signaling) including the request for the flightpath report. In some examples, a single control message (e.g., RRC signaling) may indicate the filter and may include the request for the flightpath report.

In some examples, the flightpath report indicates an algebraic equation representative of the sequence of expected geographic locations, where time is an independent variable of the algebraic equation. In some examples, the flightpath report indicates a set of geographic coordinates and altitudes for the UE 115-c representative of the sequence of expected geographic locations.

In some examples, the UE 115-c may transmit, to the network entity 105-e during an initial access procedure with the network entity 105-e, an indication of a capability of the UE 115-c to transmit the flightpath report, and the control signaling including the request for the flightpath report is responsive to the indication of the capability.

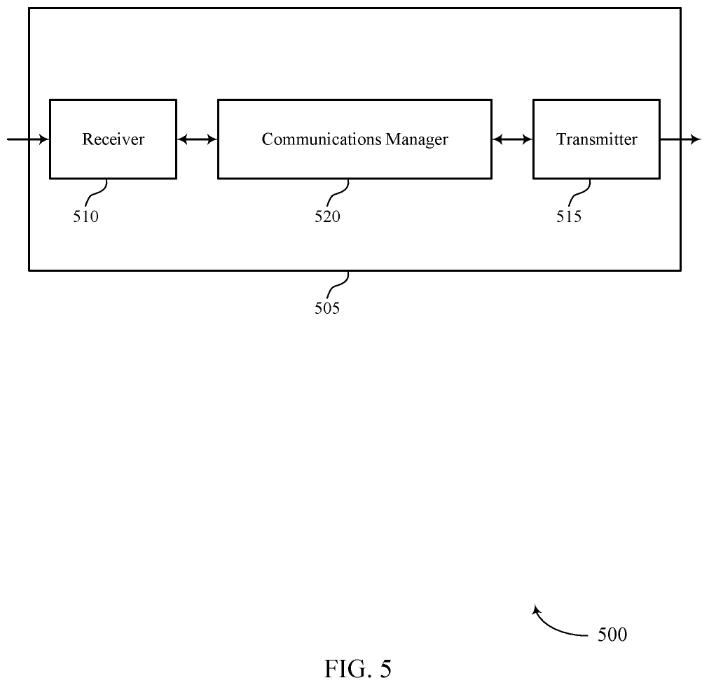

FIG. 5 shows a block diagram 500 of a device 505 that supports flight path reporting enhancements in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to flight path reporting enhancements). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to flight path reporting enhancements). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of flight path reporting enhancements as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at an AUE in accordance with examples as disclosed herein. For example, the communications manager 520 is capable of, configured to, or operable to support a means for receiving, from a network entity, control signaling including a request for a flightpath report from the AUE. The communications manager 520 is capable of, configured to, or operable to support a means for transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Additionally, or alternatively, the communications manager 520 may support wireless communications at an AUE in accordance with examples as disclosed herein. For example, the communications manager 520 is capable of, configured to, or operable to support a means for receiving, from a network entity, control signaling including a request for a flightpath report from the AUE and indicating a filter to apply to the flightpath report. The communications manager 520 is capable of, configured to, or operable to support a means for determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values. The communications manager 520 is capable of, configured to, or operable to support a means for transmitting, to the network entity and in response to the request, the flightpath report, where the flightpath report indicates the subset of expected geographic locations and the subset of expected time values.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

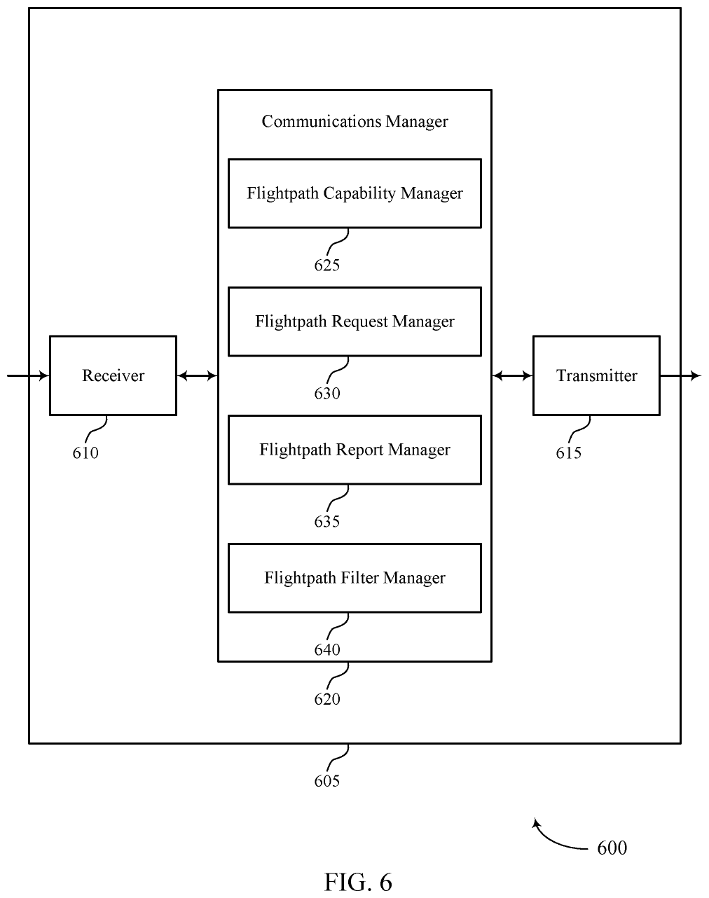

FIG. 6 shows a block diagram 600 of a device 605 that supports flight path reporting enhancements in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to flight path reporting enhancements). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to flight path reporting enhancements). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of flight path reporting enhancements as described herein. For example, the communications manager 620 may include a flightpath capability manager 625, a flightpath request manager 630, a flightpath report manager 635, a flightpath filter manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at an AUE in accordance with examples as disclosed herein. The flightpath request manager 630 is capable of, configured to, or operable to support a means for receiving, from a network entity, control signaling including a request for a flightpath report from the AUE. The flightpath report manager 635 is capable of, configured to, or operable to support a means for transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Additionally, or alternatively, the communications manager 620 may support wireless communications at an AUE in accordance with examples as disclosed herein. The flightpath request manager 630 is capable of, configured to, or operable to support a means for receiving, from a network entity, control signaling including a request for a flightpath report from the AUE and indicating a filter to apply to the flightpath report. The flightpath filter manager 640 is capable of, configured to, or operable to support a means for determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values. The flightpath report manager 635 is capable of, configured to, or operable to support a means for transmitting, to the network entity and in response to the request, the flightpath report, where the flightpath report indicates the subset of expected geographic locations and the subset of expected time values.

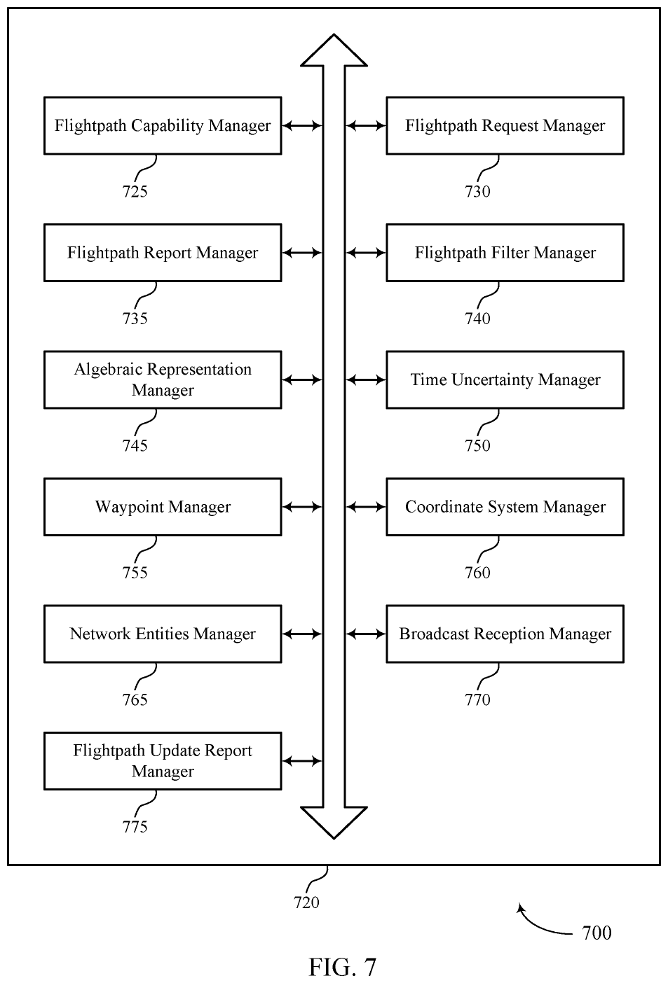

FIG. 7 shows a block diagram 700 of a communications manager 720 that supports flight path reporting enhancements in accordance with one or more aspects of the present disclosure. The communications manager 720 may be an example of aspects of a communications manager 520, a communications manager 620, or both, as described herein. The communications manager 720, or various components thereof, may be an example of means for performing various aspects of flight path reporting enhancements as described herein. For example, the communications manager 720 may include a flightpath capability manager 725, a flightpath request manager 730, a flightpath report manager 735, a flightpath filter manager 740, an algebraic representation manager 745, a time uncertainty manager 750, a waypoint manager 755, a coordinate system manager 760, a network entities manager 765, a broadcast reception manager 770, a flightpath update report manager 775, or any combination thereof. Each of these components may communicate, directly or indirectly, with one another (e.g., via one or more buses).

The communications manager 720 may support wireless communications at an AUE in accordance with examples as disclosed herein. The flightpath request manager 730 is capable of, configured to, or operable to support a means for receiving, from a network entity, control signaling including a request for a flightpath report from the AUE. The flightpath report manager 735 is capable of, configured to, or operable to support a means for transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

In some examples, to support transmitting the flightpath report, the algebraic representation manager 745 is capable of, configured to, or operable to support a means for transmitting the flightpath report that indicates an algebraic equation representative of the sequence of expected geographic locations, where time is an independent variable of the algebraic equation.

In some examples, the time uncertainty manager 750 is capable of, configured to, or operable to support a means for receiving, with the control signaling, an indication of an option to include the set of time uncertainty values in the flightpath report.

In some examples, to support transmitting the flightpath report, the waypoint manager 755 is capable of, configured to, or operable to support a means for transmitting the flightpath report that indicates a set of geographic coordinates and altitudes for the AUE representative of the sequence of expected geographic locations.

In some examples, to support transmitting the flightpath report, the flightpath report manager 735 is capable of, configured to, or operable to support a means for transmitting the flightpath report including a set of location uncertainty values corresponding to the sequence of expected geographic locations.

In some examples, the flightpath update report manager 775 is capable of, configured to, or operable to support a means for transmitting, to the network entity, a second flightpath report including updated location uncertainty information corresponding to at least a portion of the sequence of expected geographic locations.

In some examples, the coordinate system manager 760 is capable of, configured to, or operable to support a means for receiving, with the control signaling, an indication of a coordinate system for reporting the sequence of expected geographic locations in the flightpath report.

In some examples, the network entities manager 765 is capable of, configured to, or operable to support a means for receiving, from the network entity, an indication of a set of multiple network entities along the sequence of expected geographic locations. In some examples, the network entities manager 765 is capable of, configured to, or operable to support a means for monitoring for one or more messages from one or more of the set of multiple network entities based on the indication of the set of multiple network entities.

In some examples, the flightpath capability manager 725 is capable of, configured to, or operable to support a means for transmitting, to the network entity during an initial access procedure with the network entity, an indication of a capability of the AUE to transmit the flightpath report.

Additionally, or alternatively, the communications manager 720 may support wireless communications at an AUE in accordance with examples as disclosed herein. In some examples, the flightpath request manager 730 is capable of, configured to, or operable to support a means for receiving, from a network entity, control signaling including a request for a flightpath report from the AUE and indicating a filter to apply to the flightpath report. The flightpath filter manager 740 is capable of, configured to, or operable to support a means for determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values. In some examples, the flightpath report manager 735 is capable of, configured to, or operable to support a means for transmitting, to the network entity and in response to the request, the flightpath report, where the flightpath report indicates the subset of expected geographic locations and the subset of expected time values.

In some examples, to support receiving the control signaling including an indication of the filter, the flightpath filter manager 740 is capable of, configured to, or operable to support a means for receiving an indication of a geographic area corresponding to the filter, where the subset of expected geographic locations are located within the geographic area.

In some examples, the indication of the geographic area includes an indication of a center coordinate and a radius, a list of zone identifiers corresponding to geographic zones, or a combination thereof.

In some examples, to support receiving the control signaling including an indication of the filter, the flightpath filter manager 740 is capable of, configured to, or operable to support a means for receiving an indication of a time period corresponding to the filter, where the subset of expected geographic locations correspond to the subset of expected time values within the time period.

In some examples, the flightpath filter manager 740 is capable of, configured to, or operable to support a means for receiving, with the control signaling, an indication of a set of spatial filters, where the filter is a spatial filter, where the set of spatial filters includes the spatial filter, where each spatial filter includes a geographic area and an applicable altitude range, and where the spatial filter to apply is selected by the AUE based on an altitude of the AUE being within the applicable altitude range of the spatial filter.

In some examples, the flightpath filter manager 740 is capable of, configured to, or operable to support a means for receiving, with the control signaling, an indication of a set of filters and a set of corresponding times at which each of the set of filters is applicable, where the set of filters includes the filter, and where the filter to apply is selected by the AUE based on a time at which the AUE transmits the flightpath report.

In some examples, to support receiving the control signaling, the broadcast reception manager 770 is capable of, configured to, or operable to support a means for receiving a broadcast message indicating the filter. In some examples, to support receiving the control signaling, the flightpath request manager 730 is capable of, configured to, or operable to support a means for receiving a control message including the request for the flightpath report.

In some examples, to support receiving the control signaling, the flightpath request manager 730 is capable of, configured to, or operable to support a means for receiving a single control message including the request for the flightpath report and indicating the filter.

In some examples, to support transmitting the flightpath report, the algebraic representation manager 745 is capable of, configured to, or operable to support a means for transmitting the flightpath report that indicates an algebraic equation representative of the subset of expected geographic locations, where time is an independent variable of the algebraic equation.

In some examples, the waypoint manager 755 is capable of, configured to, or operable to support a means for transmitting the flightpath report that indicates a set of geographic coordinates and altitudes for the AUE representative of the subset of expected geographic locations.

In some examples, the flightpath capability manager 725 is capable of, configured to, or operable to support a means for transmitting, to the network entity during an initial access procedure with the network entity, an indication of a capability of the AUE to transmit the flightpath report, where the control signaling including the request for the flightpath report is responsive to the indication of the capability.

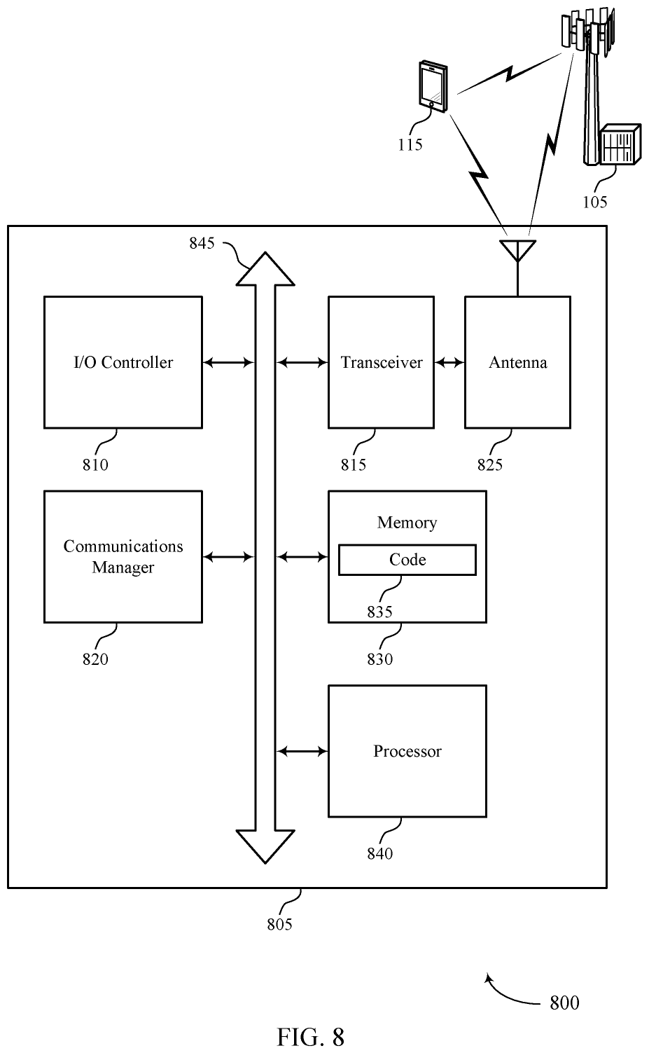

FIG. 8 shows a diagram of a system 800 including a device 805 that supports flight path reporting enhancements in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting flight path reporting enhancements). For example, the device 805 or a component of the device 805 may include a processor 840 and memory 830 coupled with or to the processor 840, the processor 840 and memory 830 configured to perform various functions described herein.

The communications manager 820 may support wireless communications at an AUE in accordance with examples as disclosed herein. For example, the communications manager 820 is capable of, configured to, or operable to support a means for receiving, from a network entity, control signaling including a request for a flightpath report from the AUE. The communications manager 820 is capable of, configured to, or operable to support a means for transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Additionally, or alternatively, the communications manager 820 may support wireless communications at an AUE in accordance with examples as disclosed herein. For example, the communications manager 820 is capable of, configured to, or operable to support a means for receiving, from a network entity, control signaling including a request for a flightpath report from the AUE and indicating a filter to apply to the flightpath report. The communications manager 820 is capable of, configured to, or operable to support a means for determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values. The communications manager 820 is capable of, configured to, or operable to support a means for transmitting, to the network entity and in response to the request, the flightpath report, where the flightpath report indicates the subset of expected geographic locations and the subset of expected time values.

By including or configuring the communications manager 820 in accordance with examples as described herein, the device 805 may support techniques for more efficient utilization of communication resources and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of flight path reporting enhancements as described herein, or the processor 840 and the memory 830 may be otherwise configured to perform or support such operations.

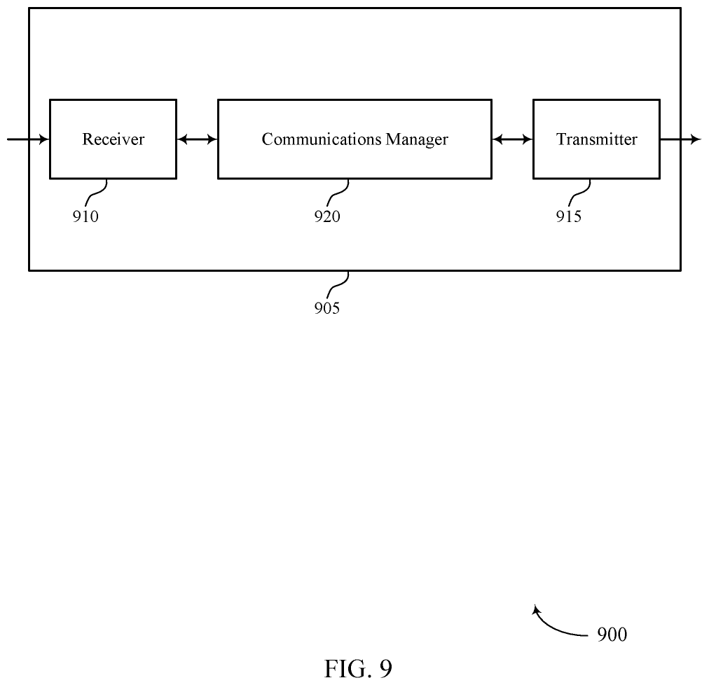

FIG. 9 shows a block diagram 900 of a device 905 that supports flight path reporting enhancements in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of flight path reporting enhancements as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for transmitting, to a AUE, control signaling including a request for a flightpath report from the AUE. The communications manager 920 is capable of, configured to, or operable to support a means for receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Additionally, or alternatively, the communications manager 920 may support wireless communications at a network entity in accordance with examples as disclosed herein. For example, the communications manager 920 is capable of, configured to, or operable to support a means for receiving, from a AUE, a flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

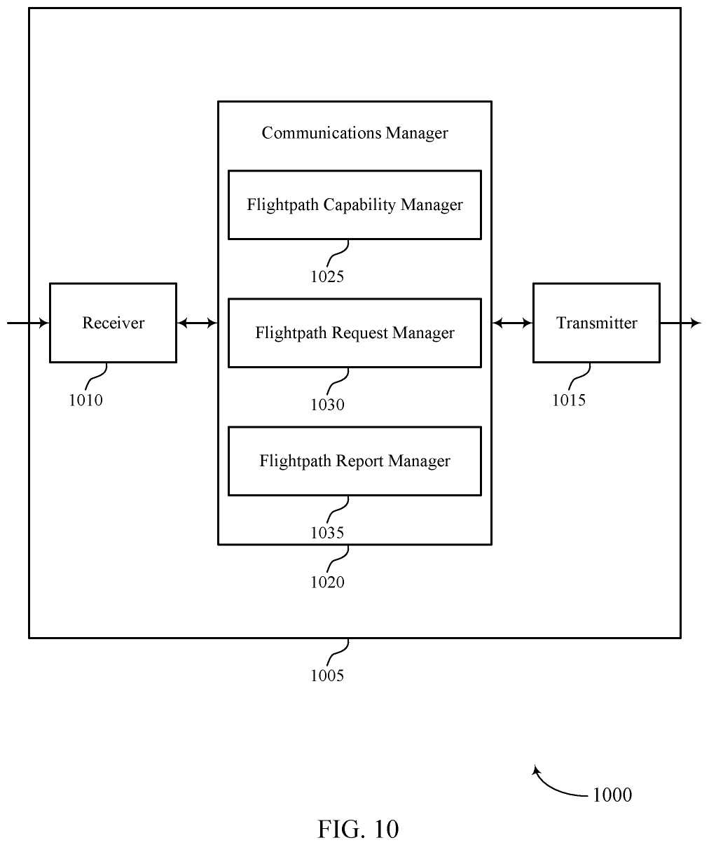

FIG. 10 shows a block diagram 1000 of a device 1005 that supports flight path reporting enhancements in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of flight path reporting enhancements as described herein. For example, the communications manager 1020 may include a flightpath capability manager 1025, a flightpath request manager 1030, a flightpath report manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The flightpath request manager 1030 is capable of, configured to, or operable to support a means for transmitting, to a AUE, control signaling including a request for a flightpath report from the AUE. The flightpath report manager 1035 is capable of, configured to, or operable to support a means for receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Additionally, or alternatively, the communications manager 1020 may support wireless communications at a network entity in accordance with examples as disclosed herein. The flightpath request manager 1030 is capable of, configured to, or operable to support a means for transmitting, to an AUE, control signaling including a request for a flightpath report from the AUE and indicating a filter to apply to the flightpath report. The flightpath report manager 1035 is capable of, configured to, or operable to support a means for receiving, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

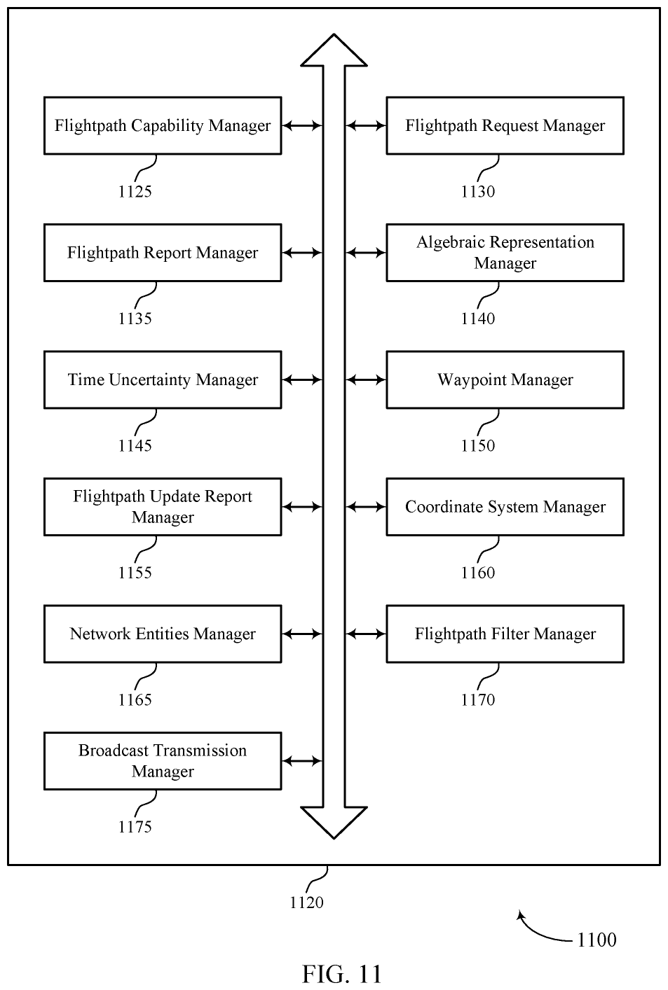

FIG. 11 shows a block diagram 1100 of a communications manager 1120 that supports flight path reporting enhancements in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of flight path reporting enhancements as described herein. For example, the communications manager 1120 may include a flightpath capability manager 1125, a flightpath request manager 1130, a flightpath report manager 1135, an algebraic representation manager 1140, a time uncertainty manager 1145, a waypoint manager 1150, a flightpath update report manager 1155, a coordinate system manager 1160, a network entities manager 1165, a flightpath filter manager 1170, a broadcast transmission manager 1175, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The flightpath request manager 1130 is capable of, configured to, or operable to support a means for transmitting, to a AUE, control signaling including a request for a flightpath report from the AUE. The flightpath report manager 1135 is capable of, configured to, or operable to support a means for receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

In some examples, to support receiving the flightpath report, the algebraic representation manager 1140 is capable of, configured to, or operable to support a means for receiving the flightpath report that indicates an algebraic equation representative of the sequence of expected geographic locations, where time is an independent variable of the algebraic equation.

In some examples, the time uncertainty manager 1145 is capable of, configured to, or operable to support a means for transmitting, with the control signaling, an indication of an option to include the set of time uncertainty values in the flightpath report.

In some examples, to support receiving the flightpath report, the waypoint manager 1150 is capable of, configured to, or operable to support a means for receiving the flightpath report that indicates a set of geographic coordinates and altitudes for the AUE representative of the sequence of expected geographic locations.

In some examples, to support receiving the flightpath report, the flightpath report manager 1135 is capable of, configured to, or operable to support a means for receiving the flightpath report including a set of location uncertainty values corresponding to the sequence of expected geographic locations.

In some examples, the flightpath update report manager 1155 is capable of, configured to, or operable to support a means for receiving, from the AUE, a second flightpath report including updated location uncertainty information corresponding to at least a portion of the sequence of expected geographic locations.

In some examples, the coordinate system manager 1160 is capable of, configured to, or operable to support a means for transmitting, with the control signaling, an indication of a coordinate system for reporting the sequence of expected geographic locations in the flightpath report.

In some examples, the network entities manager 1165 is capable of, configured to, or operable to support a means for transmitting, to the AUE, an indication of a set of multiple network entities along the sequence of expected geographic locations.

In some examples, the flightpath capability manager 1125 is capable of, configured to, or operable to support a means for receiving, from the AUE during an initial access procedure with the AUE, an indication of a capability of the AUE to transmit the flightpath report.

Additionally, or alternatively, the communications manager 1120 may support wireless communications at a network entity in accordance with examples as disclosed herein. In some examples, the flightpath request manager 1130 is capable of, configured to, or operable to support a means for transmitting, to an AUE, control signaling including a request for a flightpath report from the AUE and indicating a filter to apply to the flightpath report. In some examples, the flightpath report manager 1135 is capable of, configured to, or operable to support a means for receiving, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

In some examples, to support transmitting the control signaling including an indication of the filter, the flightpath filter manager 1170 is capable of, configured to, or operable to support a means for transmitting an indication of a geographic area corresponding to the filter, where the sequence of expected geographic locations are located within the geographic area.

In some examples, the indication of the geographic area includes an indication of a center coordinate and a radius, a list of zone identifiers corresponding to geographic zones, or a combination thereof.

In some examples, to support transmitting the control signaling including an indication of the filter, the flightpath filter manager 1170 is capable of, configured to, or operable to support a means for transmitting an indication of a time period corresponding to the filter, where the sequence of expected geographic locations correspond to the set of expected time values within the time period.

In some examples, the flightpath filter manager 1170 is capable of, configured to, or operable to support a means for transmitting, with the control signaling, an indication of a set of spatial filters, where the filter is a spatial filter, where the set of spatial filters includes the spatial filter, where each spatial filter includes a geographic area and an applicable altitude range, and where the spatial filter applied by the AUE is based on an altitude of the AUE being within the applicable altitude range of the spatial filter.

In some examples, the flightpath filter manager 1170 is capable of, configured to, or operable to support a means for transmitting, with the control signaling, an indication of a set of filters and a set of corresponding times at which each of the set of filters is applicable, where the set of filters includes the filter, and where the filter applied by the AUE is based on a time at which the AUE transmits the flightpath report.

In some examples, to support transmitting the control signaling, the broadcast transmission manager 1175 is capable of, configured to, or operable to support a means for transmitting a broadcast message indicating the filter. In some examples, to support transmitting the control signaling, the flightpath request manager 1130 is capable of, configured to, or operable to support a means for transmitting a control message including the request for the flightpath report.

In some examples, to support transmitting the control signaling, the flightpath request manager 1130 is capable of, configured to, or operable to support a means for transmitting a single control message including the request for the flightpath report and indicating the filter.

In some examples, to support receiving the flightpath report, the algebraic representation manager 1140 is capable of, configured to, or operable to support a means for receiving the flightpath report that indicates an algebraic equation representative of the sequence of expected geographic locations, where time is an independent variable of the algebraic equation.

In some examples, to support receiving the flightpath report, the waypoint manager 1150 is capable of, configured to, or operable to support a means for receiving the flightpath report that indicates a set of geographic coordinates and altitudes for the AUE representative of the sequence of expected geographic locations.

In some examples, the flightpath capability manager 1125 is capable of, configured to, or operable to support a means for receiving, from the AUE during an initial access procedure with the AUE, an indication of a capability of the AUE to transmit the flightpath report, where the control signaling including the request for the flightpath report is responsive to the indication of the capability.

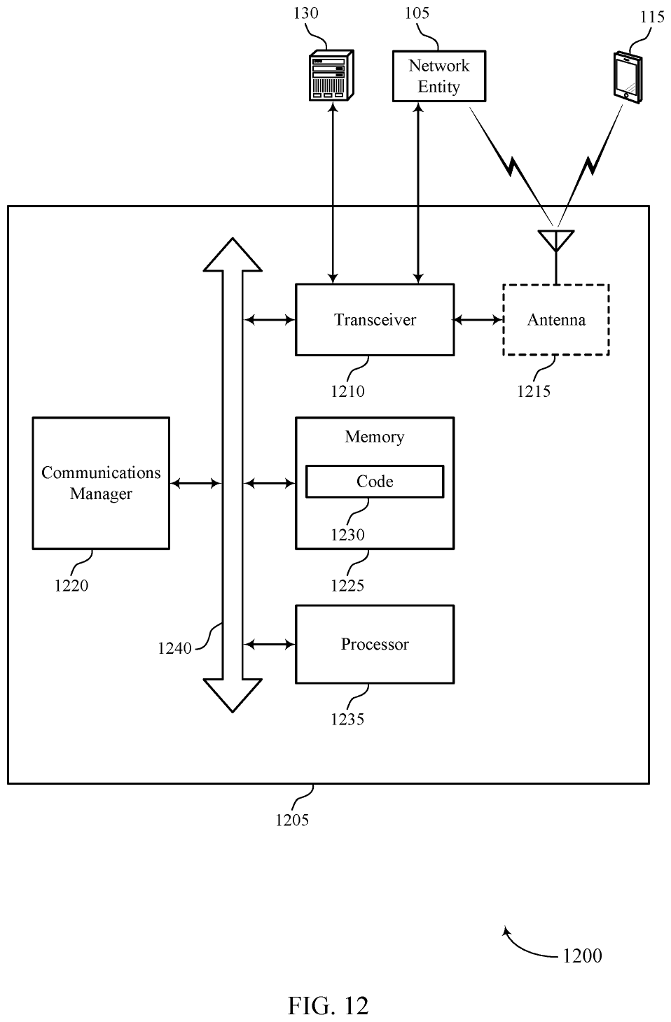

FIG. 12 shows a diagram of a system 1200 including a device 1205 that supports flight path reporting enhancements in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting flight path reporting enhancements). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for transmitting, to a AUE, control signaling including a request for a flightpath report from the AUE. The communications manager 1220 is capable of, configured to, or operable to support a means for receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values.

Additionally, or alternatively, the communications manager 1220 may support wireless communications at a network entity in accordance with examples as disclosed herein. For example, the communications manager 1220 is capable of, configured to, or operable to support a means for transmitting, to an AUE, control signaling including a request for a flightpath report from the AUE and indicating a filter to apply to the flightpath report. The communications manager 1220 is capable of, configured to, or operable to support a means for receiving, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter.

By including or configuring the communications manager 1220 in accordance with examples as described herein, the device 1205 may support techniques for more efficient utilization of communication resources and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of flight path reporting enhancements as described herein, or the processor 1235 and the memory 1225 may be otherwise configured to perform or support such operations.

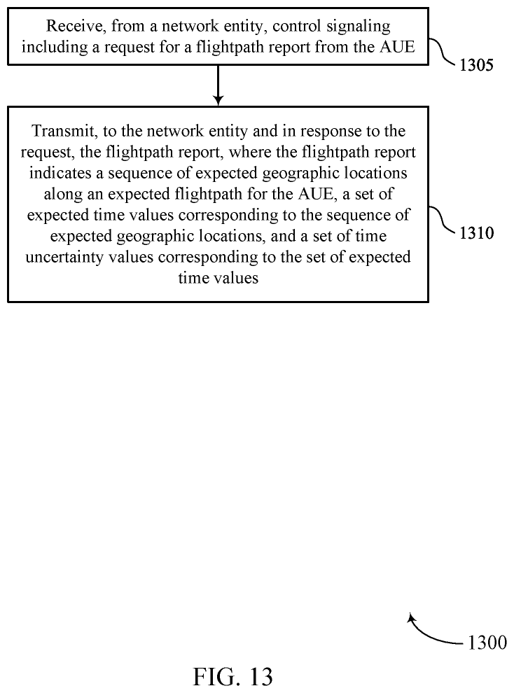

FIG. 13 shows a flowchart illustrating a method 1300 that supports flight path reporting enhancements in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving, from a network entity, control signaling including a request for a flightpath report from the AUE. The operations of 1310 may be performed in accordance with examples as disclosed herein. In some examples, aspects of the operations of 1310 may be performed by a flightpath request manager 730 as described with reference to FIG. 7.

At 1310, the method may include transmitting, to the network entity and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values. The operations of 1315 may be performed in accordance with examples as disclosed herein. In some examples, aspects of the operations of 1315 may be performed by a flightpath report manager 735 as described with reference to FIG. 7.

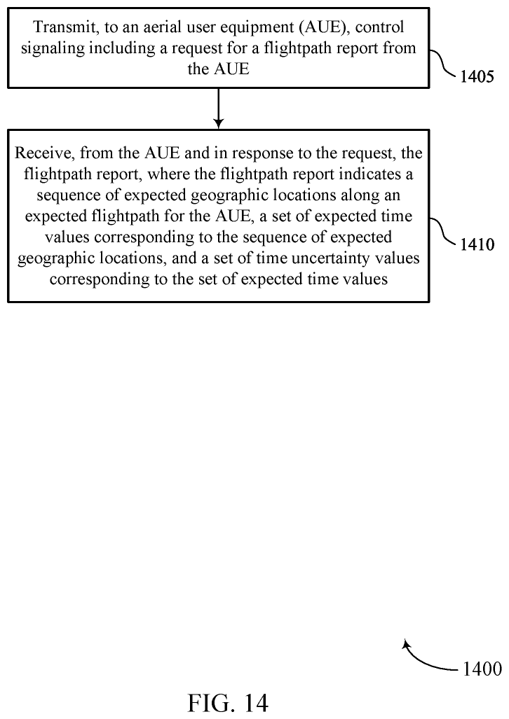

FIG. 14 shows a flowchart illustrating a method 1400 that supports flight path reporting enhancements in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1405, the method may include transmitting, to a AUE, control signaling including a request for a flightpath report from the AUE. The operations of 1410 may be performed in accordance with examples as disclosed herein. In some examples, aspects of the operations of 1410 may be performed by a flightpath request manager 1130 as described with reference to FIG. 11.

At 1410, the method may include receiving, from the AUE and in response to the request, the flightpath report, where the flightpath report indicates a sequence of expected geographic locations along an expected flightpath for the AUE, a set of expected time values corresponding to the sequence of expected geographic locations, and a set of time uncertainty values corresponding to the set of expected time values. The operations of 1415 may be performed in accordance with examples as disclosed herein. In some examples, aspects of the operations of 1415 may be performed by a flightpath report manager 1135 as described with reference to FIG. 11.

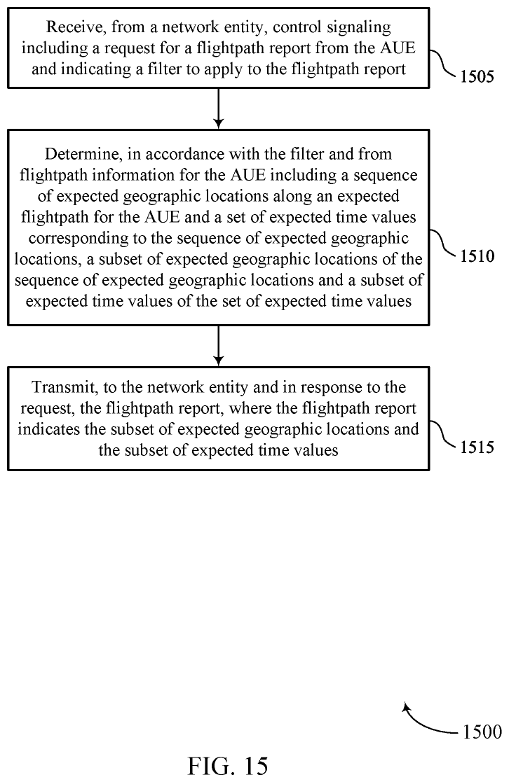

FIG. 15 shows a flowchart illustrating a method 1500 that supports flight path reporting enhancements in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving, from a network entity, control signaling including a request for a flightpath report from the AUE and indicating a filter to apply to the flightpath report. The operations of 1505 may be performed in accordance with examples as disclosed herein. In some examples, aspects of the operations of 1505 may be performed by a flightpath request manager 730 as described with reference to FIG. 7.

At 1510, the method may include determining, in accordance with the filter and from flightpath information for the AUE including a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values. The operations of 1510 may be performed in accordance with examples as disclosed herein. In some examples, aspects of the operations of 1510 may be performed by a flightpath filter manager 740 as described with reference to FIG. 7.

At 1515, the method may include transmitting, to the network entity and in response to the request, the flightpath report, where the flightpath report indicates the subset of expected geographic locations and the subset of expected time values. The operations of 1515 may be performed in accordance with examples as disclosed herein. In some examples, aspects of the operations of 1515 may be performed by a flightpath report manager 735 as described with reference to FIG. 7.

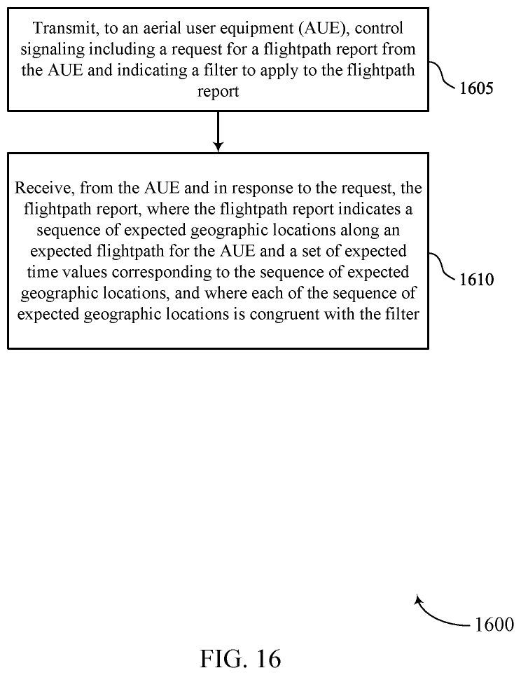

FIG. 16 shows a flowchart illustrating a method 1600 that supports flight path reporting enhancements in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include transmitting, to an AUE, control signaling including a request for a flightpath report from the AUE and indicating a filter to apply to the flightpath report. The operations of 1605 may be performed in accordance with examples as disclosed herein. In some examples, aspects of the operations of 1605 may be performed by a flightpath request manager 1130 as described with reference to FIG. 11.

At 1610, the method may include receiving, from the AUE and in response to the request, the flightpath report, where the flightpath report indicates a sequence of expected geographic locations along an expected flightpath for the AUE and a set of expected time values corresponding to the sequence of expected geographic locations, and where each of the sequence of expected geographic locations is congruent with the filter. The operations of 1610 may be performed in accordance with examples as disclosed herein. In some examples, aspects of the operations of 1610 may be performed by a flightpath report manager 1135 as described with reference to FIG. 11.

The following provides an overview of aspects of the present disclosure:
Aspect 1: A method for wireless communications at an AUE, comprising: receiving, from a network entity, control signaling including a request for a flightpath report from the AUE; and transmitting, to the network entity and in response to the request, the flightpath report, wherein the flightpath report indicates a sequence of expected geographic locations along an expected flightpath for the AUE, a set of expected time values corresponding to the sequence of expected geographic locations, and a set of time uncertainty values corresponding to the set of expected time values.
Aspect 2: The method of aspect 1, wherein transmitting the flightpath report comprises: transmitting the flightpath report that indicates an algebraic equation representative of the sequence of expected geographic locations, wherein time is an independent variable of the algebraic equation.
Aspect 3: The method of any of aspects 1 through 2, further comprising: receiving, with the control signaling, an indication of an option to include the set of time uncertainty values in the flightpath report.
Aspect 4: The method of any of aspects 1 or 3, wherein transmitting the flightpath report comprises: transmitting the flightpath report that indicates a set of geographic coordinates and altitudes for the AUE representative of the sequence of expected geographic locations.
Aspect 5: The method of any of aspects 1 through 4, wherein transmitting the flightpath report comprises: transmitting the flightpath report comprising a set of location uncertainty values corresponding to the sequence of expected geographic locations.
Aspect 6: The method of aspect 5, further comprising: transmitting, to the network entity, a second flightpath report comprising updated location uncertainty information corresponding to at least a portion of the sequence of expected geographic locations.
Aspect 7: The method of any of aspects 1 through 6, further comprising: receiving, with the control signaling, an indication of a coordinate system for reporting the sequence of expected geographic locations in the flightpath report.
Aspect 8: The method of any of aspects 1 through 7, further comprising: receiving, from the network entity, an indication of a plurality of network entities along the sequence of expected geographic locations; and monitoring for one or more messages from one or more of the plurality of network entities based at least in part on the indication of the plurality of network entities.
Aspect 9: The method of any of aspects 1 through 8, further comprising: receiving, from the AUE during an initial access procedure with the AUE, an indication of a capability of the AUE to transmit the flightpath report.
Aspect 10: A method for wireless communications at a network entity, comprising: transmitting, to an AUE, control signaling including a request for a flightpath report from the AUE; and receiving, from the AUE and in response to the request, the flightpath report, wherein the flightpath report indicates a sequence of expected geographic locations along an expected flightpath for the AUE, a set of expected time values corresponding to the sequence of expected geographic locations, and a set of time uncertainty values corresponding to the set of expected time values.
Aspect 11: The method of aspect 10, wherein receiving the flightpath report comprises: receiving the flightpath report that indicates an algebraic equation representative of the sequence of expected geographic locations, wherein time is an independent variable of the algebraic equation.
Aspect 12: The method of any of aspects 10 through 11, further comprising: transmitting, with the control signaling, an indication of an option to include the set of time uncertainty values in the flightpath report.
Aspect 13: The method of any of aspects 10 or 12, wherein receiving the flightpath report comprises: receiving the flightpath report that indicates a set of geographic coordinates and altitudes for the AUE representative of the sequence of expected geographic locations.
Aspect 14: The method of any of aspects 10 through 13, wherein receiving the flightpath report comprises: receiving the flightpath report comprising a set of location uncertainty values corresponding to the sequence of expected geographic locations.
Aspect 15: The method of aspect 14, further comprising: receiving, from the AUE, a second flightpath report comprising updated location uncertainty information corresponding to at least a portion of the sequence of expected geographic locations.
Aspect 16: The method of any of aspects 10 through 15, further comprising: transmitting, with the control signaling, an indication of a coordinate system for reporting the sequence of expected geographic locations in the flightpath report.
Aspect 17: The method of any of aspects 10 through 16, further comprising: transmitting, to the AUE, an indication of a plurality of network entities along the sequence of expected geographic locations.
Aspect 18: The method of any of aspects 10 through 17, further comprising: receiving, from the AUE during an initial access procedure with the AUE, an indication of a capability of the AUE to transmit the flightpath report.
Aspect 19: A method for wireless communications at an AUE, comprising: receiving, from a network entity, control signaling including a request for a flightpath report from the AUE and indicating a filter to apply to the flightpath report; determining, in accordance with the filter and from flightpath information for the AUE comprising a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values; and transmitting, to the network entity and in response to the request, the flightpath report, wherein the flightpath report indicates the subset of expected geographic locations and the subset of expected time values.
Aspect 20: The method of aspect 19, wherein receiving the control signaling including an indication of the filter comprises: receiving an indication of a geographic area corresponding to the filter, wherein the subset of expected geographic locations are located within the geographic area.
Aspect 21: The method of aspect 20, wherein the indication of the geographic area comprises an indication of a center coordinate and a radius, a list of zone identifiers corresponding to geographic zones, or a combination thereof.
Aspect 22: The method of any of aspects 19 through 21, wherein receiving the control signaling including an indication of the filter comprises: receiving an indication of a time period corresponding to the filter, wherein the subset of expected geographic locations correspond to the subset of expected time values within the time period.
Aspect 23: The method of any of aspects 19 through 22, further comprising: receiving, with the control signaling, an indication of a set of spatial filters, wherein the filter is a spatial filter, wherein the set of spatial filters comprises the spatial filter, wherein each spatial filter comprises a geographic area and an applicable altitude range, and wherein the spatial filter to apply is selected by the AUE based at least in part on an altitude of the AUE being within the applicable altitude range of the spatial filter.
Aspect 24: The method of any of aspects 19 through 23, further comprising: receiving, with the control signaling, an indication of a set of filters and a set of corresponding times at which each of the set of filters is applicable, wherein the set of filters comprises the filter, and wherein the filter to apply is selected by the AUE based at least in part on a time at which the AUE transmits the flightpath report.
Aspect 25: The method of any of aspects 19 through 24, wherein receiving the control signaling comprises: receiving a broadcast message indicating the filter; and receiving a control message including the request for the flightpath report.
Aspect 26: The method of any of aspects 19 through 25, wherein receiving the control signaling comprises: receiving a single control message including the request for the flightpath report and indicating the filter.
Aspect 27: The method of any of aspects 19 through 26, wherein transmitting the flightpath report comprises: transmitting the flightpath report that indicates an algebraic equation representative of the subset of expected geographic locations, wherein time is an independent variable of the algebraic equation.
Aspect 28: The method of any of aspects 19 through 24, further comprising: transmitting the flightpath report that indicates a set of geographic coordinates and altitudes for the AUE representative of the subset of expected geographic locations.
Aspect 29: The method of any of aspects 19 through 28, further comprising: transmitting, to the network entity during an initial access procedure with the network entity, an indication of a capability of the AUE to transmit the flightpath report, wherein the control signaling including the request for the flightpath report is responsive to the indication of the capability.
Aspect 30: A method for wireless communications at a network entity, comprising: transmitting, to an AUE, control signaling including a request for a flightpath report from the AUE and indicating a filter to apply to the flightpath report; and receiving, from the AUE and in response to the request, the flightpath report, wherein the flightpath report indicates a sequence of expected geographic locations along an expected flightpath for the AUE and a set of expected time values corresponding to the sequence of expected geographic locations, and wherein each of the sequence of expected geographic locations is congruent with the filter.
Aspect 31: The method of aspect 30, wherein transmitting the control signaling including an indication of the filter comprises: transmitting an indication of a geographic area corresponding to the filter, wherein the sequence of expected geographic locations are located within the geographic area.
Aspect 32: The method of aspect 31, wherein the indication of the geographic area comprises an indication of a center coordinate and a radius, a list of zone identifiers corresponding to geographic zones, or a combination thereof.
Aspect 33: The method of any of aspects 30 through 32, wherein transmitting the control signaling including an indication of the filter comprises: transmitting an indication of a time period corresponding to the filter, wherein the sequence of expected geographic locations correspond to the set of expected time values within the time period.
Aspect 34: The method of any of aspects 30 through 33, further comprising: transmitting, with the control signaling, an indication of a set of spatial filters, wherein the filter is a spatial filter, wherein the set of spatial filters comprises the spatial filter, wherein each spatial filter comprises a geographic area and an applicable altitude range, and wherein the spatial filter applied by the AUE is based at least in part on an altitude of the AUE being within the applicable altitude range of the spatial filter.
Aspect 35: The method of any of aspects 30 through 34, further comprising: transmitting, with the control signaling, an indication of a set of filters and a set of corresponding times at which each of the set of filters is applicable, wherein the set of filters comprises the filter, and wherein the filter applied by the AUE is based at least in part on a time at which the AUE transmits the flightpath report.
Aspect 36: The method of any of aspects 30 through 35, wherein transmitting the control signaling comprises: transmitting a broadcast message indicating the filter; and transmitting a control message including the request for the flightpath report.
Aspect 37: The method of any of aspects 30 through 36, wherein transmitting the control signaling comprises: transmitting a single control message including the request for the flightpath report and indicating the filter.
Aspect 38: The method of any of aspects 30 through 37, wherein receiving the flightpath report comprises: receiving the flightpath report that indicates an algebraic equation representative of the sequence of expected geographic locations, wherein time is an independent variable of the algebraic equation.
Aspect 39: The method of any of aspects 30 through 35, wherein receiving the flightpath report comprises: receiving the flightpath report that indicates a set of geographic coordinates and altitudes for the AUE representative of the sequence of expected geographic locations.
Aspect 40: The method of any of aspects 30 through 39, further comprising: receiving, from the AUE during an initial access procedure with the AUE, an indication of a capability of the AUE to transmit the flightpath report, wherein the control signaling including the request for the flightpath report is responsive to the indication of the capability.
Aspect 41: An apparatus for wireless communications at an AUE, comprising a processor; memory coupled with the processor; and instructions stored in the memory and executable by the processor to cause the apparatus to perform a method of any of aspects 1 through 9.
Aspect 42: An apparatus for wireless communications at an AUE, comprising at least one means for performing a method of any of aspects 1 through 9.
Aspect 43: A non-transitory computer-readable medium storing code for wireless communications at an AUE, the code comprising instructions executable by a processor to perform a method of any of aspects 1 through 9.
Aspect 44: An apparatus for wireless communications at a network entity, comprising a processor; memory coupled with the processor; and instructions stored in the memory and executable by the processor to cause the apparatus to perform a method of any of aspects 10 through 18.
Aspect 45: An apparatus for wireless communications at A network entity, comprising at least one means for performing a method of any of aspects 10 through 18.
Aspect 46: A non-transitory computer-readable medium storing code for wireless communications at a network entity, the code comprising instructions executable by a processor to perform a method of any of aspects 10 through 18.
Aspect 47: An apparatus for wireless communications at an AUE, comprising a processor; memory coupled with the processor; and instructions stored in the memory and executable by the processor to cause the apparatus to perform a method of any of aspects 19 through 29.
Aspect 48: An apparatus for wireless communications at an AUE, comprising at least one means for performing a method of any of aspects 19 through 29.
Aspect 49: A non-transitory computer-readable medium storing code for wireless communications at an AUE, the code comprising instructions executable by a processor to perform a method of any of aspects 19 through 29.
Aspect 50: An apparatus for wireless communications at a network entity, comprising a processor; memory coupled with the processor; and instructions stored in the memory and executable by the processor to cause the apparatus to perform a method of any of aspects 30 through 40.
Aspect 51: An apparatus for wireless communications at a network entity, comprising at least one means for performing a method of any of aspects 30 through 40.
Aspect 52: A non-transitory computer-readable medium storing code for wireless communications at a network entity, the code comprising instructions executable by a processor to perform a method of any of aspects 30 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An aerial user equipment (AUE) for wireless communications, comprising:
one or more memories storing processor-executable code; and
one or more processors coupled with the one or more memories and individually or collectively operable to execute the code to cause the AUE to:
receive, from a network entity, control signaling including a request for a flightpath report from the AUE; and
transmit, to the network entity and in response to the request, the flightpath report, wherein the flightpath report indicates a sequence of expected geographic locations along an expected flightpath for the AUE, a set of expected time values corresponding to the sequence of expected geographic locations, and a set of time uncertainty values corresponding to the set of expected time values.

2. The AUE of claim 1, wherein the flightpath report further indicates a set of geographic coordinates and altitudes for the AUE representative of the sequence of expected geographic locations, a set of location uncertainty values corresponding to the sequence of expected geographic locations, an algebraic equation representative of the sequence of expected geographic locations, wherein time is an independent variable of the algebraic equation, or a combination thereof.

3. The AUE of claim 2, wherein the one or more processors are individually or collectively further operable to execute the code to cause the AUE to:
transmit, to the network entity, a second flightpath report comprising updated location uncertainty values corresponding to at least a portion of the sequence of expected geographic locations.

4. The AUE of claim 1, wherein the one or more processors are individually or collectively further operable to execute the code to cause the AUE to:
receive, with the control signaling, an indication of a coordinate system for reporting the sequence of expected geographic locations in the flightpath report.

5. The AUE of claim 1, wherein the one or more processors are individually or collectively further operable to execute the code to cause the AUE to:
receive, from the network entity, an indication of a plurality of network entities along the sequence of expected geographic locations; and
monitor for one or more messages from one or more of the plurality of network entities based at least in part on the indication of the plurality of network entities.

6. The AUE of claim 1, wherein the one or more processors are individually or collectively further operable to execute the code to cause the AUE to:
transmit, to the network entity during an initial access procedure with the network entity, an indication of a capability of the AUE to transmit the flightpath report.

7. A network entity for wireless communications, comprising:
one or more memories storing processor-executable code; and
one or more processors coupled with the one or more memories and individually or collectively operable to execute the code to cause the network entity to:
transmit, to an aerial user equipment (AUE), control signaling including a request for a flightpath report from the AUE; and
receive, from the AUE and in response to the request, the flightpath report, wherein the flightpath report indicates a sequence of expected geographic locations along an expected flightpath for the AUE, a set of expected time values corresponding to the sequence of expected geographic locations, and a set of time uncertainty values corresponding to the set of expected time values.

8. The network entity of claim 7, wherein the flightpath report further indicates a set of geographic coordinates and altitudes for the AUE representative of the sequence of expected geographic locations, a set of location uncertainty values corresponding to the sequence of expected geographic locations, an algebraic equation representative of the sequence of expected geographic locations, wherein time is an independent variable of the algebraic equation, or a combination thereof.

9. The network entity of claim 8, wherein the one or more processors are individually or collectively further operable to execute the code to cause the AUE to:
receive, from the AUE, a second flightpath report comprising updated location uncertainty values corresponding to at least a portion of the sequence of expected geographic locations.

10. The network entity of claim 7, wherein the one or more processors are individually or collectively further operable to execute the code to cause the network entity to:
transmit, with the control signaling, an indication of a coordinate system for reporting the sequence of expected geographic locations in the flightpath report.

11. The network entity of claim 7, wherein the one or more processors are individually or collectively further operable to execute the code to cause the network entity to:
transmit, to the AUE, an indication of a plurality of network entities along the sequence of expected geographic locations.

12. The network entity of claim 7, wherein the one or more processors are individually or collectively further operable to execute the code to cause the network entity to:
receive, from the AUE during an initial access procedure with the AUE, an indication of a capability of the AUE to transmit the flightpath report.

13. The network entity of claim 7, wherein the control signaling includes an indication of a filter to apply to the flightpath report, wherein the sequence of expected geographic locations indicated in the flightpath report is congruent with the filter.

14. The network entity of claim 13, wherein, to transmit the control signaling including the indication of the filter, the one or more processors are individually or collectively operable to execute the code to cause the network entity to:
transmit an indication of a geographic area corresponding to the filter, wherein the sequence of expected geographic locations are located within the geographic area;
transmit an indication of a time period corresponding to the filter, wherein the sequence of expected geographic locations correspond to the set of expected time values within the time period; or
a combination thereof.

15. An aerial user equipment (AUE) for wireless communications, comprising:
one or more memories storing processor-executable code; and
one or more processors coupled with the one or more memories and individually or collectively operable to execute the code to cause the AUE to:
receive, from a network entity, control signaling including a request for a flightpath report from the AUE and indicating a filter to apply to the flightpath report;
determine, in accordance with the filter and from flightpath information for the AUE comprising a sequence of expected geographic locations along an expected flightpath for the AUE and a set of expected time values corresponding to the sequence of expected geographic locations, a subset of expected geographic locations of the sequence of expected geographic locations and a subset of expected time values of the set of expected time values; and
transmit, to the network entity and in response to the request, the flightpath report, wherein the flightpath report indicates the subset of expected geographic locations and the subset of expected time values.

16. The AUE of claim 15, wherein, to receive the control signaling including an indication of the filter, the one or more processors are individually or collectively operable to execute the code to cause the AUE to:
receive an indication of a geographic area corresponding to the filter, wherein the subset of expected geographic locations are located within the geographic area;
receive an indication of a time period corresponding to the filter, wherein the subset of expected geographic locations correspond to the subset of expected time values within the time period; or
a combination thereof.

17. The AUE of claim 15, wherein the one or more processors are individually or collectively further operable to execute the code to cause the AUE to:
receive, with the control signaling, an indication of a set of spatial filters, wherein the filter is a spatial filter, wherein the set of spatial filters comprises the spatial filter, wherein each spatial filter comprises a geographic area and an applicable altitude range, and wherein the spatial filter to apply is selected by the AUE based at least in part on an altitude of the AUE being within the applicable altitude range of the spatial filter.

18. The AUE of claim 15, wherein the one or more processors are individually or collectively further operable to execute the code to cause the AUE to:
receive, with the control signaling, an indication of a set of filters and a set of corresponding times at which each of the set of filters is applicable, wherein the set of filters comprises the filter, and wherein the filter is selected by the AUE based at least in part on a time at which the AUE transmits the flightpath report.

19. The AUE of claim 15, wherein the flightpath report further indicates a set of geographic coordinates and altitudes for the AUE representative of the subset of expected geographic locations, an algebraic equation representative of the subset of expected geographic locations, wherein time is an independent variable of the algebraic equation, or a combination thereof.

20. The AUE of claim 15, wherein the one or more processors are individually or collectively further operable to execute the code to cause the AUE to:
transmit, to the network entity during an initial access procedure with the network entity, an indication of a capability of the AUE to transmit the flightpath report, wherein the control signaling including the request for the flightpath report is responsive to the indication of the capability.
